(19) United States
(12) Patent Application Publication
(10) Pub. No.: US 2008/0025310 A1
(43) Pub. Date: Jan. 31, 2008

(54) Data relaying apparatus, data relaying method, and computer product

(75) Inventor: Katsuya Niigata, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/601,625

(22) Filed: Nov. 20, 2006

(30) Foreign Application Priority Data
Jul. 31, 2006 (JP) 2006-209175

(51) Int. Cl. H04L 12/56

(52) U.S. Cl. 370/392

(57) ABSTRACT

A data relaying apparatus includes an encrypting unit and a decrypting unit. The encrypting unit receives data from a first computing device from among computing devices, encrypts the received data, and forwards the encrypted data to a first storage device from among storage devices. The decrypting unit receives encrypted data from the first storage device, decrypts the received data, and forwards the decrypted data to the first computing device.

### BACKGROUND OF THE INVENTION

1. Field of the Invention

The present invention relates to a technology for relaying data between a plurality of computing devices and a plurality of storage devices.

2. Description of the Related Art

Computer devices store large amount of data in external storage devices.

However, if data is stored unencrypted in the external storage device, there is a security risk including theft or damage to the stored data when the storage device is unwillingly connected to another computing device. Therefore various technologies have been proposed to reduce data storage risk.

For example, Japanese Patent Laid-Open Application No. 2005-322201 discloses a system of a plurality of computing devices, including computers and the like, connected to external storage devices, where each external storage device encrypts data received from the computing devices and stores the encrypted data therein.

However, the technology costs much, because each external storage device must have faculty of encrypting data when storing the data therein.

### SUMMARY OF THE INVENTION

It is an object of the present invention to at least partially solve the problems in the conventional technology.

According to an aspect of the present invention, a data relaying apparatus that relays data between a plurality of computing devices and a plurality of storage devices includes an encrypting unit that receives data from a first computing device from among the computing devices, encrypts received data, and forwards encrypted data to a first storage device from among the storage devices; and a decrypting unit that receives encrypted data from the first storage device, decrypts received data, and forwards decrypted data to the first computing device.

According to another aspect of the present invention, a method of relaying data between a plurality of computing devices and a plurality of storage devices, the method includes receiving data from a first computing device from among the computing devices; encrypting received data that is received from the first computing device; forwarding encrypted data to a first storage device from among the storage devices; receiving encrypted data from the first storage device; decrypting received data that is received from the first storage device; and forwarding decrypted data to the first computing device.

According to still another aspect of the present invention, a computer-readable recording medium stores therein a computer program that causes a computer to implement the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a data relaying apparatus according to a first embodiment of the present invention;

FIG. 2 is a block diagram of the data relaying apparatus shown in FIG. 1;

FIG. 3 is a flowchart of a data encryption process according to the first embodiment;

FIG. 4 is a flowchart of a data decryption process according to the first embodiment;

FIG. 5 is a schematic for explaining a data relaying apparatus according to a second embodiment of the present invention;

FIG. 6 is a drawing for explaining setting data stored in the data relaying apparatus shown in FIG. 5;

FIG. 7 is a flowchart of a data encryption process according to the second embodiment;

FIG. 8 is a flowchart of a data decryption process according to the second embodiment;

FIG. 9 is a schematic for explaining a data relaying apparatus according to a third embodiment of the present invention;

FIG. 10 is a flowchart of a data encryption process according to the third embodiment;

FIG. 11 is a flowchart of a data decryption process according to the third embodiment;

FIG. 12 is a schematic for explaining a data relaying apparatus according to a fourth embodiment of the present invention;

FIG. 13 is a schematic for explaining a data relaying apparatus according to the fourth embodiment; and

FIG. 14 is a block diagram of a computer system that executes a data relaying program.

### DETAILED DESCRIPTION OF THE PREFERRED EMBODIMENTS

Exemplary embodiments of the present invention are described below with reference to the accompanying drawings.

Described are an overview, salient feature, a configuration, process flow, and effects of the data relaying apparatus according to the first embodiment of the present invention.

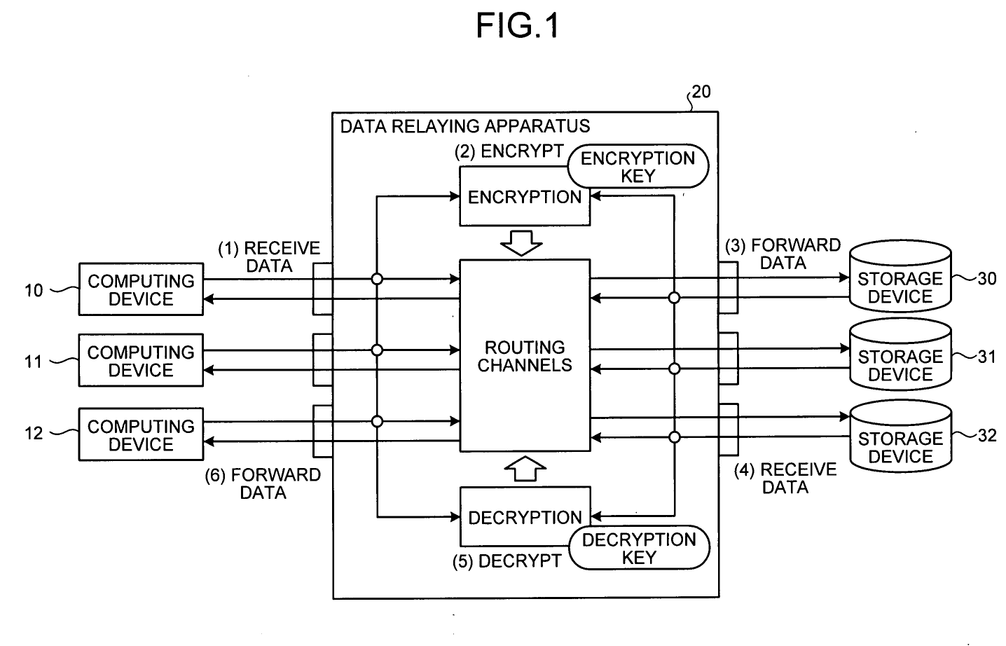

FIG. 1 is a schematic for explaining the data relaying apparatus according to the first embodiment.

The system shown in FIG. 1 includes a plurality of computing devices 10 to 12 that process data, a plurality of storage devices 30 to 32 that store the data processed by the computing devices 10 to 12, respectively, and a data relaying apparatus 20 mediating between the computing devices 10 to 12 and the storage devices 30 to 32. The data relaying apparatus 20 controls, based on routing channels stored therein, accesses to a computing device out of the computing devices 10 to 12 and accesses a storage device of the storage devices 30 to 32 to relay data therebetween.

Specifically, the data relaying apparatus 20 has stored therein predefined routing channels, for example, a routing channel that would allow the computing device 10 to access the storage device 30 but not the storage device 31. The data relaying apparatus 20 performs routing control based on such predefined routing channels stored therein. By performing routing control, the data relaying apparatus 20 receives data from the computing devices 10 to 12 and forwards the received data to the storage devices 30 to 32, enabling the data to be written to the storage devices 30 to 32, and likewise, receives data read from the storage devices 30 to 32 by the computing devices 10 to 12 and forwards the read data to the computing devices 10 to 12, enabling the data stored in the storage devices 30 to 32 to be read.

The computing devices 10 to 12 can be configured by personal computers or workstations, the data relaying apparatus 20 be a network device such as a router or a fabric switch, and the storage devices 30 to 32 be any external storage device having a hard disk.

The salient feature of the data relaying apparatus 20 according to the first embodiment is that the cost involved in making the data processed by the computing devices and stored in the storage devices secure can be cut down.

Specifically, upon receiving a request from a computing device to write data into a storage device, the data relaying apparatus 20 receives the data from the computing device and encrypts the received data (see (1) and (2) of FIG. 1). For example, the data relaying apparatus 20 receives from the computing device 10 the data to be stored in the storage device 30 and encrypts the data.

The data relaying apparatus 20 then forwards the encrypted data to targeted storage device (see (3) of FIG. 1). Specifically, the data relaying apparatus 20 forwards, based on the routing channel stored therein, the encrypted data to the storage device 30. Thus, the data relaying apparatus 20 receives the data from the computing device 10 in an unencrypted form, encrypts the data, and sends the encrypted data to the storage device 30. In other words, the computing device 10 writes to the storage device 30 via the data relaying apparatus 20.

Upon receiving a request from a computing device to read data from a storage device, the data relaying apparatus 20 decrypts the encrypted data received from the storage device (see (4) and (5) of FIG. 1). For example, the data relaying apparatus 20 decrypts the encrypted data read by the computing device 10 from the storage device 30.

The data relaying apparatus 20 then forwards the decrypted data to the source computing device that issued the read data request (see (6) of FIG. 1). Thus, the data relaying apparatus 20 receives the encrypted data read by the computing device 10 from the storage device 30, decrypts the encrypted data, and forwards the decrypted data to the computing device 10. In other words, the computing device 10 reads the data from the storage device 30 by decrypting the encrypted data stored in the storage device 30 via the data relaying apparatus 20.

Thus, in a storage system where a data relaying apparatus, using for example, a router or a fabric switch, mediates between a plurality of computing devices that process data and a plurality of storage devices that encrypt and store the data processed by the computing devices, the need for providing the encryption function in all the storage devices is obviated by providing the encryption function in the data relaying apparatus. As a result, the cost involved in making the data processed by a plurality of computing devices and stored in a plurality of storage devices secure can decrease.

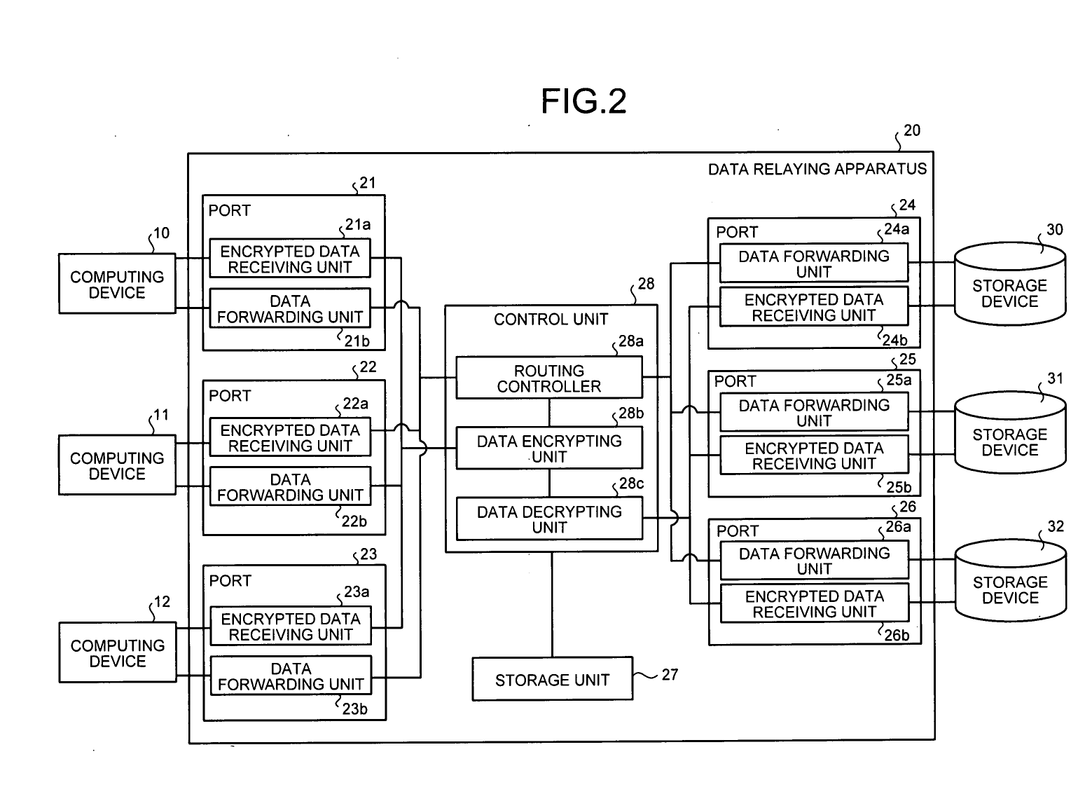

The configuration of the data relaying apparatus shown in FIG. 1 is described next. FIG. 2 is a block diagram for explaining the data relaying apparatus 20 shown in FIG. 1. The data relaying apparatus 20 includes ports 21 to 23, ports 24 to 26, a storage unit 27, and a control unit 28.

The port 21 receives data from the connected computing devices as well as forwards the data read from the storage devices to the computing devices, and includes an encrypted data receiving unit 21a and a data forwarding unit 21b. The ports 22 and 23 are identical to the port 21 and therefore not described.

The encrypted data receiving unit 21a receives data from the computing devices. Specifically, the encrypted data receiving unit 21a receives the data to be written to the storage device 30 and write data request or read data request from the computing device 10.

The data forwarding unit 21b forwards the data read from the storage devices to the source computing device that issued the read data request. Specifically, the data forwarding unit 24b reads the data from the storage device 30, and the port 21b forwards it to the computing device 10 after it is decrypted by a data decrypting unit 28c described later.

The port 24 receives the data read by the computing devices from the storage devices and forwards the data to the source computing device, and includes a data forwarding unit 24a, and an encrypted data receiving unit 24b. The ports 25 and 26 are identical to the port 24 and hence not described.

The data forwarding unit 24a forwards encrypted data and a write data request or read data request from the computing devices to the storage devices. Specifically, the data forwarding unit 24a forwards to the storage device 30 the data sent from the computing device 10 and encrypted by a data encrypting unit 28b, or a write data request and read data request sent from the computing device 10 and receiving by the encrypted data receiving unit 21a.

The encrypted data receiving unit 24b receives from the storage devices the data to be sent to the computing devices. Specifically, the encrypted data receiving unit 24b receives the encrypted data from the storage devices based on the read data request generated by and sent from the computing device 10.

The storage unit 27 stores therein data and programs required for the processes of the control unit 28. The storage unit 27 stores therein, for example, encryption keys required for encryption by the data encrypting unit 28b and decryption by the data decrypting unit 28c, the routing channels connecting the computing devices 10 to 12 and the storage devices 30 to 32, etc.

The control unit 28 includes an internal memory for storing programs for performing various process procedures and necessary data. In close relevance to the embodiment, the control unit 28 includes a routing controller 28a, the data encrypting unit 28b, and the data decrypting unit 28c.

The routing controller 28a charts out routing of all the computing devices and the storage devices. Specifically, the routing controller 28a sends, based on the routing channel stored in the storage unit 27, the write data request or the read data request received from the encrypted data receiving unit 21a or the encrypted data encrypted by the data encrypting unit 28b to the storage device 30 via the port 24, or the data decrypted by the data decrypting unit 28c to the computing device 10 via the port 21.

The data encrypting unit 28b encrypts the data received from the computing devices. Specifically, the data encrypting unit 28b encrypts the data the encrypted data receiving unit 21a receives from the computing device 10 using the encryption key stored in the storage unit 27, and sends the encrypted data to the routing controller 28a.

The data decrypting unit 28c decrypts the data received from the storage device. Specifically, upon receiving the encrypted data stored in the storage device 30 according to the read data request from the computing device 10, the data decrypting unit 28c decrypts the encrypted data using the encryption key stored in the storage unit 27, and sends the decrypted data to the routing controller 28a.

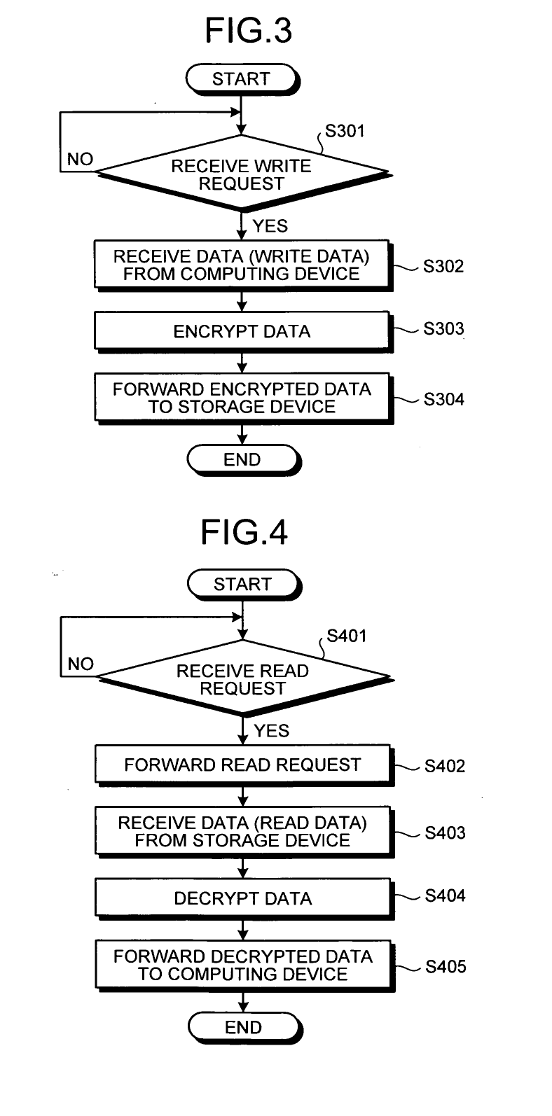

A data encryption process performed by the data relaying apparatus is described below. FIG. 3 is a flowchart of the data encryption process.

Upon receiving a write data request from a computing device (Yes at step S301), the data relaying apparatus 20 receives the data (the write data) from the computing device (step S302), encrypts the received data using the encryption key stored in the storage device (step S303), and forwards the encrypted data to the storage device (step S304).

Specifically, upon receiving a write data request from the computing device 10, the data relaying apparatus 20 receives the write data from the computing device 10, and encrypts the received data using the encryption key stored in the storage unit 27. The data relaying apparatus 20 then sends the encrypted data to the routing controller 28a, which in turn, sends the encrypted data to the port 24 to which the storage device is connected. The data forwarding unit 24a of the port 24 sends the encrypted data to the storage device 30.

A data decryption process performed by the data relaying apparatus is described below. FIG. 4 is a flowchart of the data decryption process.

Upon receiving a read data request from a computing device (Yes at step S401), the data relaying apparatus 20 forwards the read data request to the destination storage device (step S402), which in response sends the encrypted data to the data relaying apparatus 20. Upon receiving the encrypted data from the destination storage device (step S403), the data relaying apparatus 20 decrypts the encrypted data using the decryption key stored in the storage unit 27 (step S404), and forwards the decrypted data to the computing device (step S405).

Specifically, upon receiving a read data request from the computing device 10, the routing controller 28a of the data relaying apparatus 20 sends the read data request to the destination storage device 30. The encrypted data receiving unit 24b of the data relaying apparatus 20 receives the encrypted data from the destination storage device 30 that received the read data request. The data decrypting unit 28c decrypts the encrypted data using the decryption key stored in the storage unit 27, and sends the decrypted data to the routing controller 28a. The routing controller 28a sends the decrypted data to the port 21 to which the source computing device 10 that sent the read data request connects. The data forwarding unit 21b of the port 21 then forwards the data to the computing device 10.

Thus, in the data relaying apparatus according to the first embodiment, the data received from the computing devices are encrypted and the data received from the storage devices are decrypted. Consequently, in a storage system where the data relaying apparatus, for example, a router or a fabric switch, mediates between a plurality of computing devices that process data and a plurality of storage devices that store the data processed by the computing devices, the need for providing the encryption function in all the storage devices is obviated by providing the encryption function in the data relaying apparatus. As a result, the cost involved in making the data processed by a plurality of computing devices and stored in a plurality of storage devices secure can be cut down.

In the first embodiment, all the data received by the data relaying apparatus is encrypted. However, the data from different computing devices may be treated differently, that is, may nor may not be encrypted.

The data relaying apparatus according to a second embodiment of the present invention has process description settings that specify whether the data received from a particular computing device is to be encrypted or passed on unencrypted and processes the data according to the process description setting. An overall configuration of a system that includes the data relaying apparatus according to the second embodiment and effects due to the second embodiment are described below.

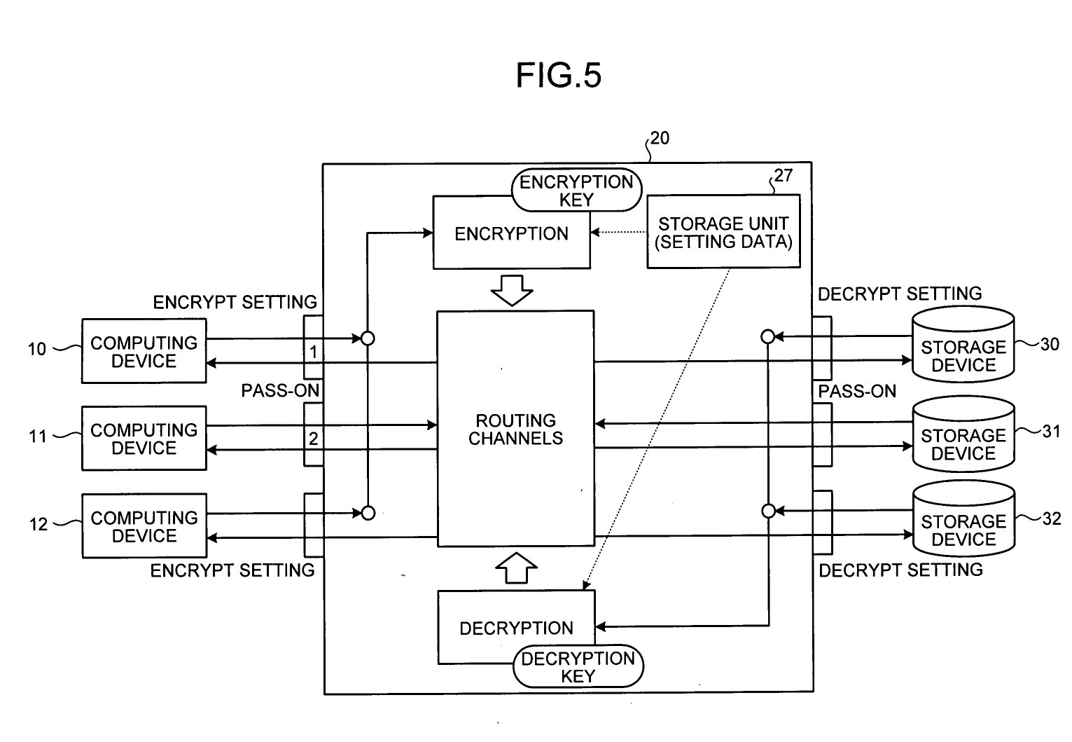

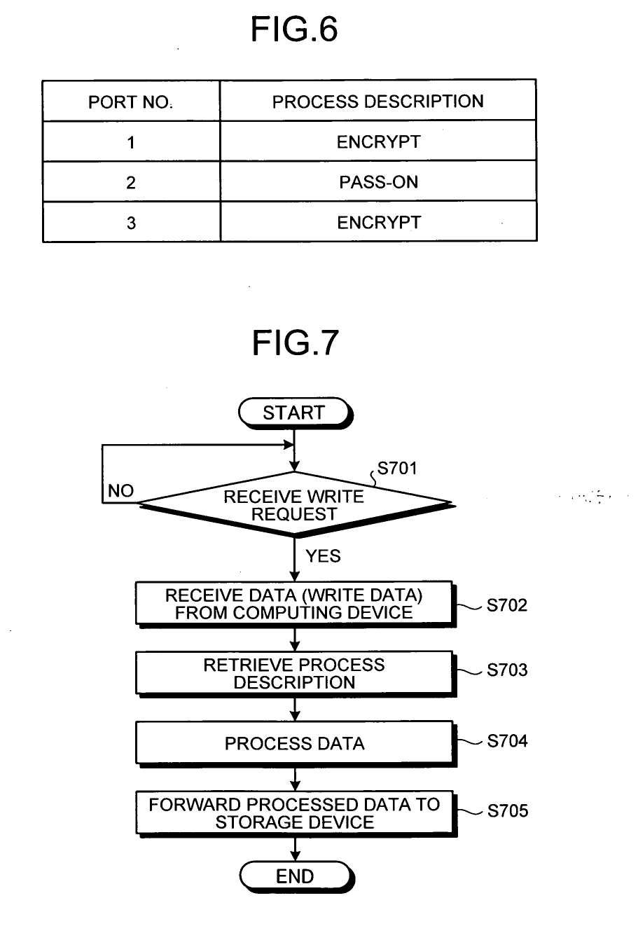

The overall configuration of the data relaying apparatus according to the second embodiment is described below with reference to FIG. 5 and FIG. 6. FIG. 5 is a schematic for explaining the data relaying apparatus according to the second embodiment. FIG. 6 is a drawing of setting data stored in the data relaying apparatus shown in FIG. 5.

The system shown in FIG. 5 is identical to the system described in the first embodiment and includes the plurality of computing devices 10 to 12 that process data, the plurality of storage devices 30 to 32 that store the data processed by the computing devices 10 to 12, respectively, and the data relaying apparatus 20 mediating between the computing devices 10 to 12 and the storage devices 30 to 32. The data relaying apparatus 20 controls, based on routing channels stored therein, which of the computing devices 10 to 12 accesses (for data transmission or reading) which of the storage devices 30 to 32.

The data relaying apparatus 20 has stored in the storage unit 27 the process description setting in the form of an Encrypt setting and a Pass-on setting. The Encrypt setting indicates that the data from a computing device to be stored in a storage device is to be encrypted. The Pass-on setting indicates that the data from a computing device is to merely passed on to a storage device to be stored unencrypted. Specifically, as shown in FIG. 6, the storage unit 27 of the data relaying apparatus 20 has stored therein data such as “Port 1, Encrypt”, “Port 2, Pass-on”, “Port 1” and “Port 2” being Port No. indicating the port number to which the computing device is connected and “Encrypt” and “Pass-on” are Process Description Settings, Encrypt indicating, that the data is to be encrypted and Pass-on indicating that the data is to be passed on unencrypted.

The data relaying apparatus 20 receives data from the computing devices 10 to 12 and forwards the data to the storage devices 30 to 32 as well as receives the data read from the storage device by the computing device and forwards the data to the computing device.

Upon receiving data from a computing device for which the setting in the storage unit 27 is Encrypt, the data relaying apparatus 20 encrypts the data. Likewise, upon receiving data from a computing device for which the setting in the storage unit 27 is Pass-on, the data relaying apparatus 20 forwards the data without encrypting.

For example, upon receiving a write data request from the computing device 10 connected to the port 1, the data relaying apparatus 20 receives the write data from the computing device 10, and retrieves the setting data (Port 1, Encrypt) from the storage unit 27. The data relaying apparatus 20 then encrypts the data using the encryption key stored in the storage unit 27, and forwards the encrypted data to the storage device 30. In other words, all the data sent via the data relaying apparatus 20 from the computing device 10 are stored in the storage device 30 in an encrypted form.

Upon receiving a read data request from the computing device 10, the data relaying apparatus 20 receives from the storage device 30 the encrypted data to be forwarded to the computing device 10 connected to the port 1. The data relaying apparatus 20 then decrypts the encrypted data using the encryption key stored in the storage unit 27 and forwards the decrypted data to the computing device 10. In other words, as the setting for the port 1 to which the computing device 10 is connected is Encrypt, the data relaying apparatus 20 encrypts the data the computing device 10 sends for storing in the storage device 30, and decrypts the data the computing device 10 reads from the storage device 30.

On the other hand, upon receiving a write data request from the computing device 11 connected to the port 2, the data relaying apparatus 20 receives the write data from the computing device 11, and retrieves the setting data (Port 2, Pass-on) from the storage unit 27. The data relaying apparatus 20 then forwards the data to the storage device 31 without encrypting it based on the setting information. In other words, all the data sent via the data relaying apparatus 20 from the computing device 11 are stored in the storage device 31 in an unencrypted form.

Upon receiving a read data request from the computing device 11, the data relaying apparatus 20 receives from the storage device 31 the data to be forwarded to the computing device 11 connected to the port 2, and forwards it to the computing device 11 without encrypting it. In other words, as the setting for the port 2 to which the computing device 11 is connected is Pass-on, the data relaying apparatus 20 sends the data from the computing device 10 for storing in the storage device 30 without encrypting, and therefore does not need to decrypt the data the computing device 10 reads from the storage device 30.

Thus, the Encrypt and Pass-on setting for the ports to which the computing devices are connected can be changed as the situation demands, enabling data from any particular computing device to be forwarded in an encrypted form or unencrypted form.

A data encryption process of the data relaying apparatus according to the second embodiment is described below. FIG. 7 is a flowchart of the data encryption process according to the second embodiment.

Upon receiving a write data request from a computing device (Yes at step S701), the data relaying apparatus 20 receives the write data (step S702), retrieves from the storage unit 27 the process description setting corresponding to the computing device that sent the data (step S703), processes the data according to the process description setting (step S704), and forwards the data to the storage device (step S705).

Specifically, upon receiving a write data request from the computing device 10 connected to the port 1, the data relaying apparatus 20 receives the write data from the computing device 10, and retrieves the setting data (Port 1, Encrypt) from the storage unit 27. Based on the setting data, the data relaying apparatus 20 encrypts the data using the encryption key stored in the storage unit 27, and forwards the encrypted data to the storage device 30.

Upon receiving a write data request from the computing device 11 connected to the port 2, the data relaying apparatus 20 receives the write data from the computing device 11 and retrieves the setting data (Port 2, Pass-on) from the storage unit 27. Based on the setting data, the data relaying apparatus 20 forwards the data to the storage device 31 without encrypting.

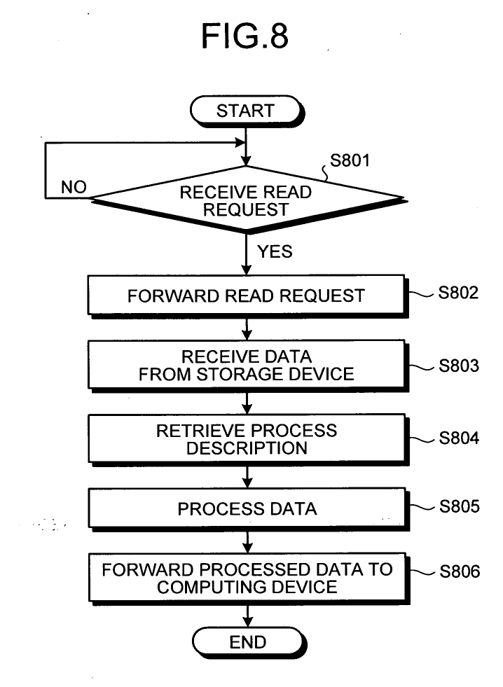

A data decryption process performed by the data relaying apparatus according to the second embodiment is described below. FIG. 8 is a flowchart of the data decryption process according to the second embodiment.

Upon receiving a read data request from a computing device (Yes at step S801), the data relaying apparatus 20 forwards the read data request to the destination storage device (step S802), which in response sends the requested data in an encrypted form to the data relaying apparatus. Upon receiving the encrypted data from the destination storage device (step S803), the data relaying apparatus 20 retrieves the process description setting corresponding to the computing device that issued the read data request (step S804), processes the data according to the retrieved process description setting (step S805), and forwards the processed data to the source computing device (step S806).

Specifically, upon receiving a read data request from the computing device 10, the data relaying apparatus 20 forwards the read data request to the storage device 30. The data relaying apparatus 20 then receives from the storage device 30 the encrypted data to be forwarded to the computing device 10 connected to the port 1 and decrypts the data using the decryption key stored in the storage unit 27.

On the other hand, upon receiving a read data request from the computing device 11, the data relaying apparatus 20 forwards the read data request to the storage device 31. The data relaying apparatus 20 then receives from the storage device 31 the unencrypted data to be forwarded to the computing device 11 connected to the port 2, and forwards the unencrypted data as it is to the computing device 11.

Thus, in the data relaying apparatus according to the second embodiment, process description settings are stored indicating whether data from a particular computing device is to be encrypted to create encrypted data or the data is to be merely forwarded unencrypted, and the data from a computing device is treated according to the stored process description setting. Consequently, process description settings for the ports to which the computing devices are connected can be changed as the situation demands, enabling data from any particular computing device to be forwarded in an encrypted form or unencrypted form.

In the first embodiment and the second embodiment, a single encryption key is used for encrypting the data received from all the computing devices. However, a different encryption key can be used for every computing device.

The data relaying apparatus according to a third embodiment of the present invention uses a different encryption key for encrypting data from every computing device. An overall configuration of a system that includes the data relaying apparatus according to the third embodiment and effects due to the third embodiment are described below.

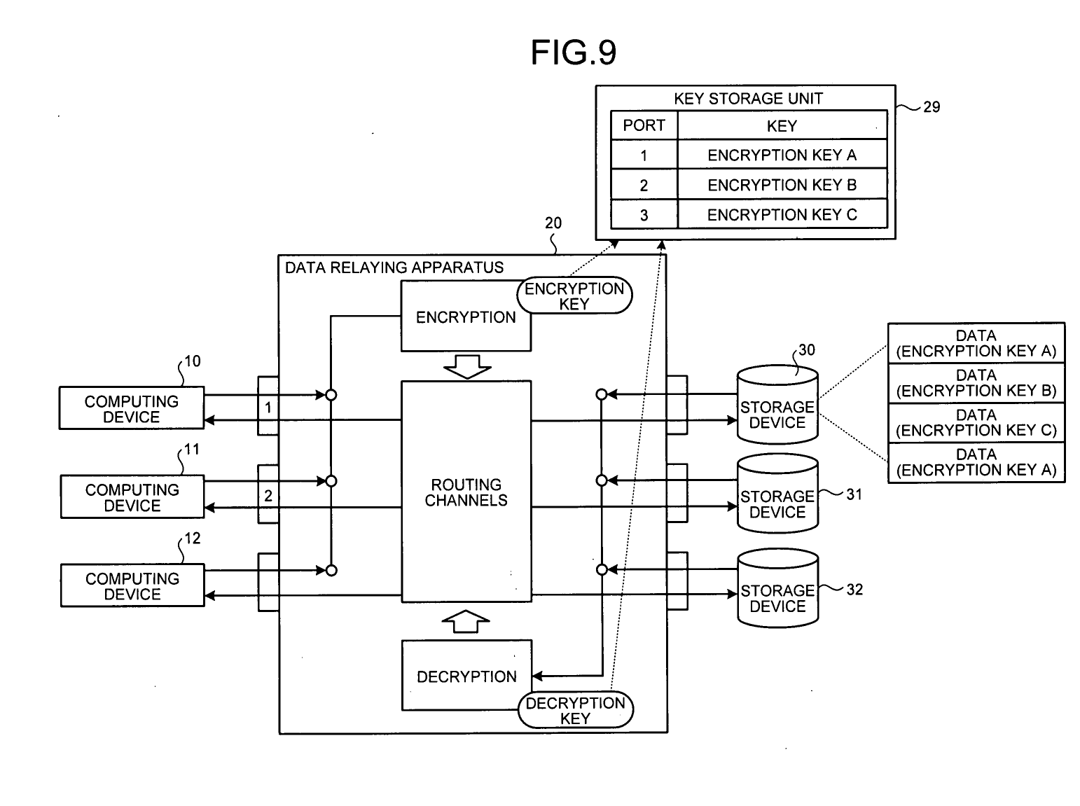

The overall configuration of the system that includes the data relaying apparatus according to the third embodiment is described below. FIG. 9 is a schematic for explaining the data relaying apparatus according to the third embodiment.

The system shown in FIG. 9 is identical to the system described in the first embodiment and includes the plurality of computing devices 10 to 12 that process data, the plurality of storage devices 30 to 32 that store the data processed by the computing devices 10 to 12, respectively, and the data relaying apparatus 20 mediating between the computing devices 10 to 12 and the storage devices 30 to 32. The data relaying apparatus 20 controls, based on routing channels stored therein, which of the computing devices 10 to 12 accesses (for data transmission or reading) which of the storage devices 30 to 32.

The data relaying apparatus 20 further includes a key storage unit 29 that has stored therein a different encryption key for every computing device. Specifically, the key storage unit 29 of the data relaying apparatus 20 has stored therein data such as “Port 1, Encryption Key A”, “Port 2, Encryption Key B”, Port 1 and Port 2 being Port No. indicating the port number to which the computing device is connected and Key indicating the key to be used for encryption.

The data relaying apparatus 20 receives data from the computing devices 10 to 12 and forwards the data to the storage devices 30 to 32 as well as receives the data read from the storage device by the computing device and forwards the data to the computing device.

When storing data from a computing device into a storage device, the data relaying apparatus 20 uses the key corresponding to the computing device for encrypting the data.

Specifically, upon receiving a write data request from the computing device 10 connected to the port 1, the data relaying apparatus 20 receives the write data from the computing device 10 and retrieves from the key storage unit 29 Encryption Key A that corresponds to the computing device 10. The data relaying apparatus 20 then uses Encryption Key A to encrypt the data received from the computing device 10 and forwards the encrypted data to the storage device 30.

Upon receiving a write data request from the computing device 11, the data relaying apparatus 20 receives the write data from the computing device 11 and retrieves from the key storage unit 29 Encryption Key B that corresponds to the computing device 11. The data relaying apparatus 20 then uses Encryption Key B to encrypt the data received from the computing device 11 and forwards the encrypted data to the storage device 30.

That is, data from all the computing devices encrypted using the encryption keys of the corresponding computing devices are all stored in the same storage device 30 (see FIG. 9), as the routing is configured so as to enable the computing devices 10 to 12 to access the storage devices 30 to 32, respectively.

When reading data from a storage device for a computing device, the data relaying apparatus 20 decrypts the encrypted data received from the storage device. Specifically, upon receiving a read data request from the computing device 10, the data relaying apparatus 20 receives from the storage device 31 the data to be sent to the computing device 10 connected to the port 1 in an encrypted form. The data relaying apparatus 20 then decrypts the encrypted data using Encryption Key A (Decryption Key A), and forwards the decrypted data to the computing device 10.

Upon receiving a read data request from the computing device 11, the data relaying apparatus 20 receives from the storage device 31 the data to be forwarded to the computing device 11 connected to the port 2. The data relaying apparatus 20 then decrypts the encrypted data using Encryption Key B (Decryption Key B), and forwards the decrypted data to the computing device 11.

Thus, by using a different encryption key for every computing device connected to different ports, security of data being stored in the storage devices can be further improved compared to when a common encryption key is used for all the ports to which the computing devices are connected.

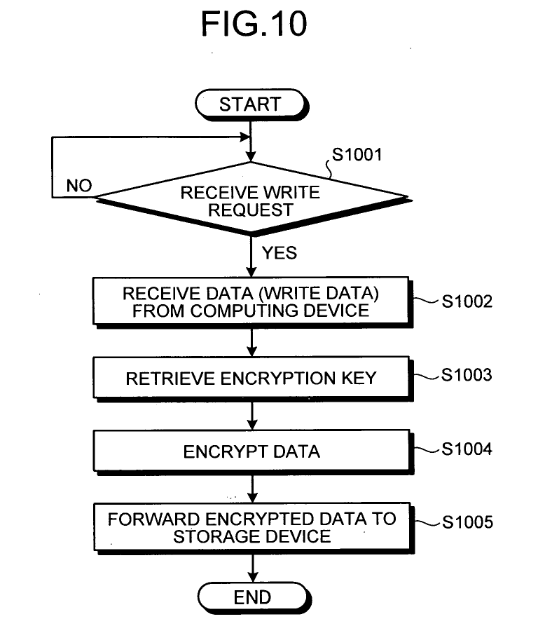

A data encryption process of the data relaying apparatus according to the third embodiment is described below. FIG. 10 is a flowchart of the data encryption process according to the third embodiment.

Upon receiving a write data request from a computing device (Yes at step S1001), the data relaying apparatus 20 receives the write data (step S1002), reads the stored encryption key corresponding to the computing device (step S1003), encrypts the data using the encryption key (step S1004), and forwards the encrypted data to the destination storage device (step S1005).

Specifically, upon receiving a write data request from the computing device 10 connected to the port 1, the data relaying apparatus 20 receives the write data, and retrieves the key in the key storage unit 29 corresponding to the computing device 10 (Port 1, Encryption Key A). The data relaying apparatus 20 then encrypts the data using Encryption Key A retrieved from the key storage unit 29 and forwards the encrypted data to the storage device 30.

Upon receiving a write data request from the computing device 11 connected to the port 2, the data relaying apparatus 20 receives the write data, and retrieves the key * corresponding to the computing device 11, Port 2, Encryption Key B, in the key storage unit 29. The data relaying apparatus 20 then encrypts the data using Encryption Key B retrieved from the key storage unit 29 and forwards the encrypted data to the storage device 30.

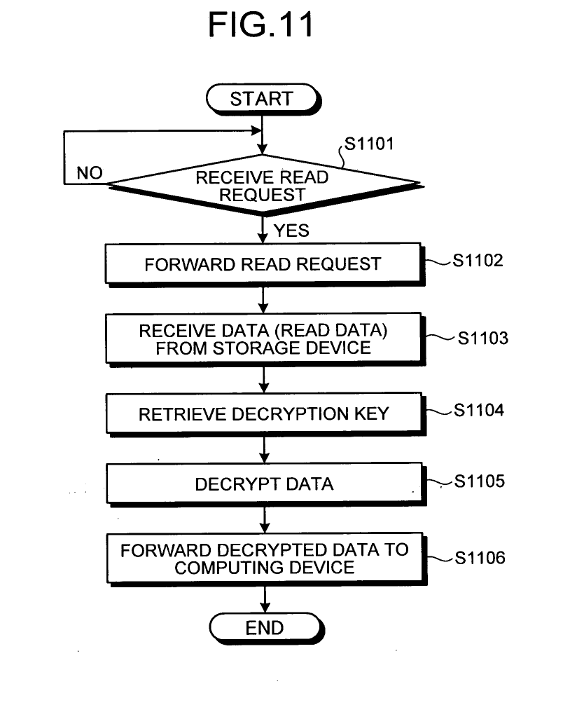

A data decryption process of the data relaying apparatus according to the third embodiment is described below. FIG. 11 is a flowchart of the data decryption process according to the third embodiment.

Upon receiving a read data request from a computing device (Yes at step S1101), the data relaying apparatus 20 forwards the read data request to the destination storage device (step S1102), which in response sends the encrypted data to the data relaying apparatus 20. Upon receiving the encrypted data (step S1103), the data relaying apparatus 20 retrieves the decryption key corresponding to the storage device from the key storage unit 29 (step S1104), decrypts the data using the decryption key (step S1105), and forwards the decrypted data to the source computing device (step S1106).

Specifically, upon receiving a read data request from the computing device 10, the data relaying apparatus 20 forwards the read data request to the storage device 30. The data relaying apparatus then receives from the storage device 30 the data to be sent to the computing device 10 connected to the port 1, because the data sent from the computing device 10 is encrypted using Encryption Key A. The data relaying apparatus 20 then decrypts the encrypted data using Encryption Key A (Decryption Key A) retrieved from the key storage unit 29 and forwards the decrypted data to the computing device 10.

Upon receiving a read data request from the computing device 11, the data relaying apparatus 20 forwards the read data request to the storage device 30. The data relaying apparatus 20 then receives from the storage device 30 the encrypted data to forward to the computing device 11 connected to the port 2 the encrypted data being encrypted by Encryption Key B, because the data sent from the computing device 11 through port 2 is encrypted using Encryption Key B. The data relaying apparatus 20 then decrypts the encrypted data using Decryption Key B retrieved from the key storage unit 29 and forwards the decrypted data to the computing device 11.

Thus, in the data relaying apparatus according to the third embodiment, a different encryption key is used for encrypting data from every computing device connected to different ports. Consequently, security of data being stored in the storage devices can be further improved compared to when a single encryption key is used for all the ports.

The embodiments described above allow various modifications. The modifications to the described embodiments are collectively described as a fourth embodiment of the present invention.

In the second embodiment, the data relaying apparatus has stored therein the process description setting for every computing device connected to the system. The process description setting for the computing devices connected to the system can be stored associated with a timeslot data that can be dynamically changed to specify the timeslot in which the process description for the computing devices is going to be valid.

Specifically, the storage unit of the data relaying apparatus has stored therein data such as “Port 1, 0:00-12:00, Encrypt”, “Port 2, 9:00-13:00, Pass-on”, including Valid Duration in addition to Port No. and Process Description Setting.

For example, upon receiving data to be forwarded to the storage device from the computing device connected to the port 1 at 10:00 hrs., the data relaying apparatus forwards the data to the storage device in an encrypted form, whereas upon receiving data to be forwarded to the storage device from the computing device connected to the port 2 at 10:00 hrs., the data relaying apparatus forwards the data to the storage device in an unencrypted form.

Likewise, upon receiving data to be forwarded to the storage device from the computing device connected to the port 1 at 12:50 hrs, the data relaying apparatus forwards the data to the storage device in an unencrypted form, whereas upon receiving data to be forwarded to the storage device from the computing device connected to the port 2 at 12:50 hrs., the data relaying apparatus forwards the data to the storage device in an encrypted form.

When receiving data from the storage device data read by the computing device, if the data is in an encrypted form, the data relaying apparatus decrypts the data before forwarding the data to the computing device, and if the data is in an unencrypted form, the data relaying apparatus forwards the data to the computing device as it is.

Thus, the process description setting, including Encrypt/Decrypt, Pass-on, can be set according to the requirement in a given timeslot, for example, by setting the process description setting to Pass-On during a timeslot in which the storage devices are likely to be accessed a great deal and to Encrypt during a timeslot in which backup data is stored.

In the first embodiment, all the data received by the data relaying apparatus is encrypted. However, the data relaying apparatus may be configured so that encryption process or passing on process is performed based on a request from the computing device.

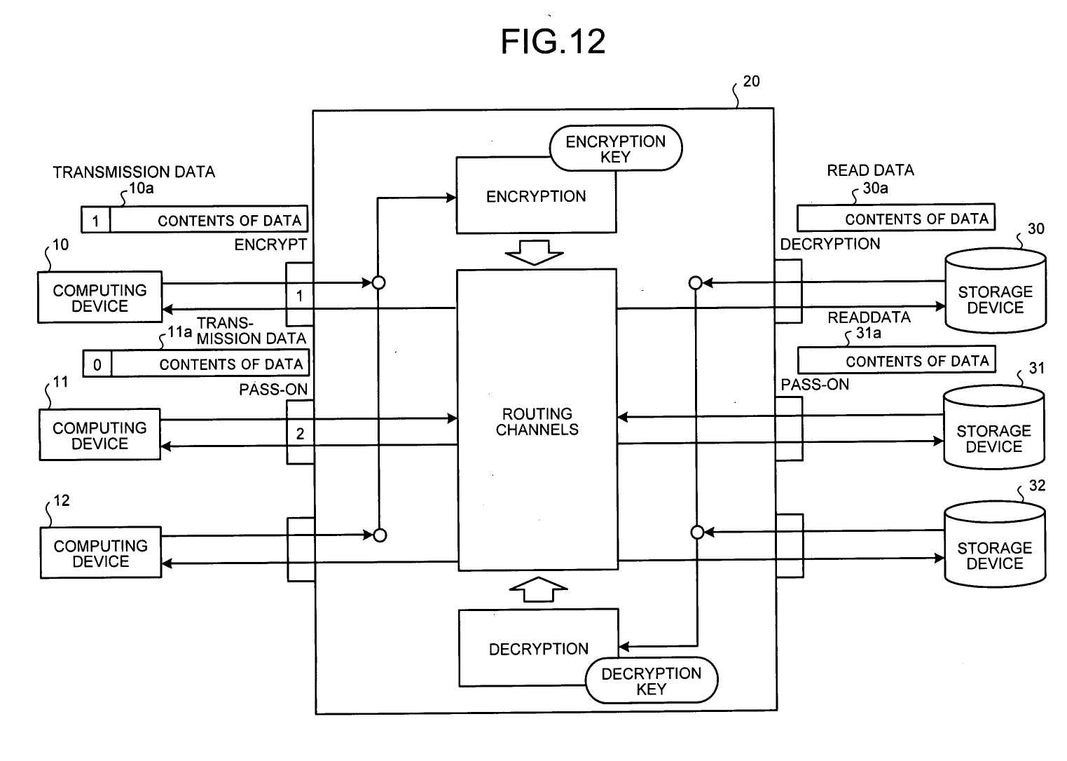

FIG. 12 is a schematic for explaining a data relaying apparatus according to the fourth embodiment. The system shown in FIG. 12 is identical to the system described in the first embodiment and includes the plurality of computing devices 10 to 12 that process data, the plurality of storage devices 30 to 32 that store the data processed by the computing devices 10 to 12, respectively, and the data relaying apparatus 20 mediating between the computing devices 10 to 12 and the storage devices 30 to 32.

In this system, the computing device sends to the data relaying apparatus 20 an Encrypt request indicating that the data is to be encrypted or a Pass-on request indicating that the data is not to be encrypted, along with the data to be stored in the storage device. The data relaying apparatus 20 encrypts and sends the data to the storage device or sends the data to the storage device unencrypted based on whether an Encrypt request is received or a Pass-on request is received with the data.

Specifically, the computing device sends to the data relaying apparatus 20 an Encrypt request indicating that the data is to be encrypted or a Pass-on request indicating that the data is not to be encrypted, along with the data to be stored in the storage device. The data relaying apparatus 20 encrypts and sends the data to the storage device if an command bit “1” is received with the data and sends the data to the storage device unencrypted if a command bit “0” is received with the data.

For example, as shown in FIG. 12, when writing data to the storage device, upon receiving transmission data 10a along with the command bit “1” from the computing device 10, the data relaying apparatus 20 encrypts the transmission data 10a before forwarding it to the storage device 30. Upon receiving write data 11a along with the command bit “0” from the computing device 11, the data relaying apparatus 20 forwards the write data 11a to the storage device 31 in an unencrypted form.

Likewise, as shown in FIG. 12, when reading data from the storage device 30, upon receiving from the storage device 30 read data 30a according to a read data request from the computing device 10, the data relaying apparatus 20 decrypts the read data 30a before forwarding it to the computing device 10. Upon receiving from the storage device 31 read data 31a according to a read request from the computing device 11, the data relaying apparatus 20 forwards the read data 31a to the computing device 11 in an unencrypted form.

Thus, by enabling encryption process or passing on process to be performed based on the command bit, in which “0” indicates “Pass-on”, and “1”, indicates “Encrypt”, attached to the data, user is afforded flexibility to change the process mode of the ports as the situation demands compared to when the process description setting is set for every port.

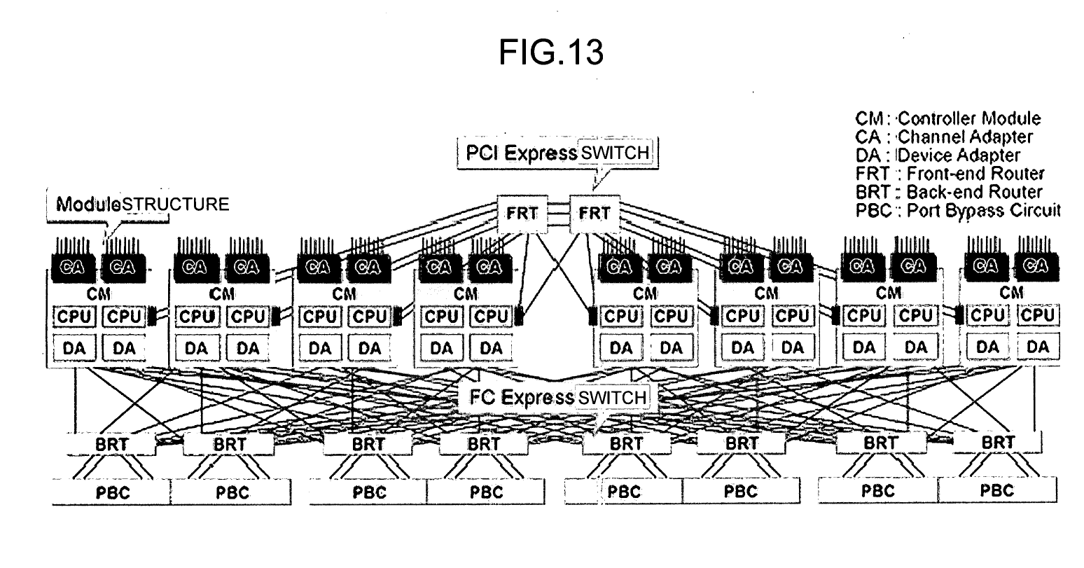

FIG. 13 is a schematic for explaining a data relaying apparatus according to the fourth embodiment. The data relaying apparatus in the first to third embodiments functions as a device mediating between the computing devices and the storage devices. However, as shown in FIG. 13, the data relaying apparatus can be implemented in a single storage system.

The storage system shown in FIG. 13 includes a plurality of controller modules (CM) that forward various data to back-end routers (BRT), a plurality of back-end routers that receive the data from the CM and forward the data to port bypass circuits (PBC) as well as receive from the PBC the data read by the CM and forward the data to the CM, and a plurality of PBC that forward the data read by the CM to a storage device. The CM is functionally identical to the computing devices 10 to 12 shown in FIG. 1, FIG. 5, and FIG. 9, and BRT is functionally identical to the data relaying apparatus 20. In other words, BRT includes the encryption (decryption) function described in the first to third embodiments. The BRT has stored therein routing channels that define routings of the CM and the PBC. A plurality of computing devices is connected to a channel adapter (CA) of each CM, a plurality of not shown storage devices are connected to each PBC.

In the storage system configured as described above, upon receiving a write data request from the computing device connected to the CA of the CM, the CM receives from the computing device the data to be sent to the BPC, and forwards the received data to the BRT. The BRT receives the data from the CM and encrypts it before forwarding the data to the PBC based on the routing channel stored in the BRT. The PBC then forwards the encrypted data to the storage device.

Upon receiving a read data request from the computing devices connected to the CA, the CM forwards the read data request to the destination storage device. The storage device sends the requested data to the PBC. The PBC forwards the data received from the storage device to the BRT. The BRT decrypted the data received from the PBC, and forwards the decrypted to the CM to which the source computing device is connected. The CM sends the decrypted data to the source computing device.

Thus, by implementing the data relaying apparatus in a storage system, the number of computing devices and storage devices can be further increased. Further, as the BRT connecting each computing device and storage device is equipped with the encryption and decryption functions, the need for providing encryption and decryption functions in each computing device or storage device is obviated. Thus, a specialized storage system can be provided in which security can be heightened without a corresponding increase in the cost.

In the data relaying apparatus according to the first to third embodiment, the process description setting of the data relaying apparatus can be changed for every computing device connected to the system. The same function can be demonstrated in the storage system according to the present embodiment by configuring the BRT such that the setting can be changed for every CM connected to the computing device.

For example, the storage system according to the present embodiment can be configured to demonstrate the function described in the second embodiment by configuring the BRT to store process description setting in the form of an Encrypt setting or Pass-on setting for every CM that connects to the computing device, and process data based on the process description setting.

The storage system according to the present embodiment can be configured to demonstrate the function described in the third embodiment by configuring the BRT to encrypt data using a different encryption key for every CM, yielding the same effect.

In the first to third embodiment, the same key is used both as encryption key and decryption key. However, different keys can be used for encryption and decryption. Private-key cryptography or public-key cryptography may be employed for encryption.

The constituent elements of the apparatus illustrated are merely conceptual and may not necessarily physically resemble the structures shown in the drawings. For instance, the apparatus need not necessarily have the structure that is illustrated. The apparatus as a whole or in parts can be broken down or integrated either functionally or physically in accordance with the load or how the device is to be used, for example, the data encrypting unit 28b and the data decrypting unit 28c can be integrated. The process functions performed by the apparatus are entirely or partially realized by a CPU or a program executed by the CPU or by a hardware using wired logic.

The process procedures, the control procedures, specific names, and data, including various parameters (for example, settings stored in the storage unit shown in FIG. 6) mentioned in the description and drawings can be changed as required unless otherwise specified.

The processes described in the embodiments described above can be realized by causing a computer system such as a personal computer or a workstation to execute a ready program. A computer system that executes a program that demonstrates the functions described in the embodiments according to the present invention is described below.

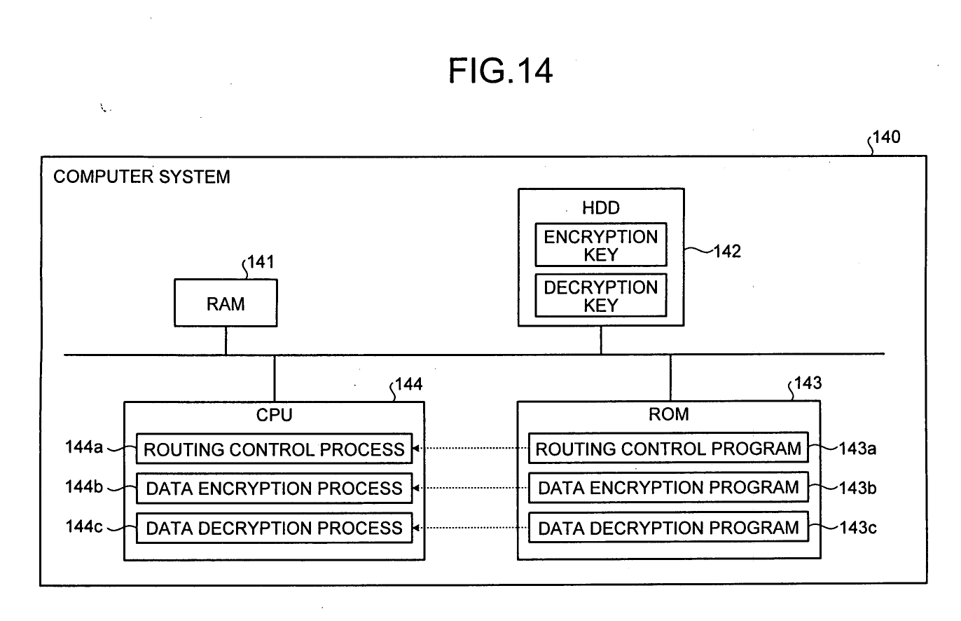

FIG. 14 is a block diagram of a computer system 140 that executes a data relaying program. The computer system 140 includes a random access memory (RAM) 141, a hard disk device (HDD) 142, a read-only memory (ROM) 143, and a central processing unit (CPU) 144. The ROM 143 stores therein programs that demonstrate the functions described in the embodiments, namely, a routing control program 143a, a data encryption program 143b, and a data decryption program 143c.

The CPU 144 performs a routing control process 144a by reading the routing control program 143a, a data encryption process 144b by reading the data encryption program 143b, and a data decryption process 144c by reading the data decryption program 143c. The routing control process 144a, the data encryption process 144b, and the data decryption process 144c correspond, respectively, to the routing controller 28a, the data encrypting unit 28b, and the data decryption unit 28c shown in FIG. 2.

The HDD 142 stores therein the encryption key and the decryption key used for encrypting or decrypting the data in the data encryption process 144b or the data decryption process 144c.

Apart from the ROM 143, the routing control program 144a, the data encryption program 144b, and the data decryption program 144c may be stored in a portable medium, a fixed medium, or on another computer system connected to the computer system 140 via a public circuit, Internal, local area network (LAN) or wide area network (WAN). The portable medium can be a flexible disk (FD) insertable into the computer system 140, compact disk-read-only memory (CD-ROM), magneto-optic (MO) disk, digital versatile disk (DVD), or integrated circuit (IC) card. The fixed medium can be a hard disk drive built into the computer system 140 or provided externally. The computer system can download the program from any of these mediums and execute them.

According to the embodiment the present invention, the data relaying apparatus encrypts data received from a computing device, creating encrypted data and decrypts data received from a storage device creating decrypted data. As a result, the need for providing encryption and decryption function in every storage device or every computing device is obviated, thus cutting down the cost involved in making the data secure. Specifically, in a storage system where the data relaying apparatus, for example, a router or a fabric switch, mediates between a plurality of computing devices that process data and a plurality of storage devices that encrypt and store the data processed by the computing devices, the need for providing the encryption function in all the storage devices is obviated by providing the encryption function in the data relaying apparatus.

According to the embodiment of the present invention, the data relaying apparatus has stored therein a process description setting for every computing device in the form of an Encrypt setting indicating that the data received from the computing device is to be encrypted and a Pass-on setting indicating that the data received from the computing device is to be passed on unencrypted. The data relaying apparatus encrypts the data upon receiving data from a computing device that has the Encrypt setting, and passes on the data unencrypted upon receiving data a computing device that has the Pass-on setting. As a result, the Encrypt setting and Pass-on setting for the ports to which the computing devices are connected can be changed as the situation demands, enabling data from any particular computing device to be forwarded in an encrypted from or unencrypted form.

According to the embodiment of the present invention, the data relaying apparatus has stored therein a timeslot data associated with the Encrypt setting and the Pass-on setting, enabling the data relaying apparatus to encrypt the data or pass on the data unencrypted according to the timeslot in which the data is received. As a result, the process description setting (Encrypt/Decrypt, Pass-on can be set according to the requirement in a given timeslot.

According to the embodiment of the present invention, the data relaying apparatus has stored therein a different encryption key for every computing device and encrypts data from a particular computing device using the encryption key of that computing device. As a result, security of data being stored in the storage devices can be further improved compared to when a common encryption key is used for all the ports to which computing devices are connected.

According to the embodiment of the present invention, the data to be stored in the storage device is sent by the computing device along with a process request in the form of an Encrypt request indicating that the data received from the computing device is to be encrypted or a Pass-on request indicating that the data received from the computing device is to be passed on unencrypted. The data relaying apparatus encrypts the data or passes on the data in an unencrypted form according to the process request. As a result, user is afforded flexibility to change the process mode of the ports as the situation demands compared to when the process description setting is set for every port.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A data relaying apparatus that relays data between a plurality of computing devices and a plurality of storage devices, the data relaying apparatus comprising:
an encrypting unit that receives data from a first computing device from among the computing devices, encrypts received data, and forwards encrypted data to a first storage device from among the storage devices; and
a decrypting unit that receives encrypted data from the first storage device, decrypts received data, and forwards decrypted data to the first computing device.

2. The data relaying apparatus according to claim 1, further comprising an encryption determining unit that determines whether the encrypting unit is to encrypt the received data that is received from the first computing device, or forward the received data as it is to the first storage device.

3. The data relaying apparatus according to claim 2, wherein the encryption determining unit determines whether the encrypting unit is to encrypt the received data, or forward the received data as it is to the first storage device based on time when the encrypting unit receives the data from the first computing device.

4. The data relaying apparatus according to claim 1, further comprising a key-storage unit that stores therein an encrypting key designated for each of the computing devices, wherein
the encrypting unit encrypts the received data that is received from the first computing device by using an encrypting key stored in the key-storage unit corresponding to the first computing device.

5. The data relaying apparatus according to claim 1, further comprising an encryption determining unit that receives designating information from the first computing device, and determines whether the encrypting unit is to encrypt the received data that is received from the first computing device or forward the received data as it is to the first storage device based on received designating information.

6. A method of relaying data between a plurality of computing devices and a plurality of storage devices, the method comprising:
receiving data from a first computing device from among the computing devices;
encrypting received data that is received from the first computing device;
forwarding encrypted data to a first storage device from among the storage devices;
receiving encrypted data from the first storage device;
decrypting received data that is received from the first storage device; and
forwarding decrypted data to the first computing device.

7. The method according to claim 6, further comprising determining whether to encrypt the received data that is received from the first computing device, or to forward the received data as it is to the first storage device.

8. The method according to claim 7, wherein the determining includes determining whether to encrypt the received data, or to forward the received data as it is to the first storage device based on time at the receiving data received from the first computing device.

9. The method according to claim 6, wherein the encrypting includes encrypting the received data by using an encrypting key designated for each of the first computing device.

10. The method according to claim 6, further comprising:
receiving designating information from the first computing device; and
determining whether to encrypt the received data that is received from the first computing device or to forward the received data as it is to the first storage device based on the designating information.

11. A computer-readable recording medium that stores therein a computer program that causes a computer to implement a method of relaying data between a plurality of computing devices and a plurality of storage devices, the computer program causing the computer to execute:
receiving data from a first computing device from among the computing devices;
encrypting received data that is received from the first computing device;
forwarding encrypted data to a first storage device from among the storage devices;
receiving encrypted data from the first storage device;
decrypting received data that is received from the first storage device; and
forwarding decrypted data to the first computing device.

12. The computer-readable recording medium according to claim 11, wherein the computer program further causes the computer to execute determining whether to encrypt the received data that is received from the first computing device, or to forward the received data as it is to the first storage device.

13. The computer-readable recording medium according to claim 12, wherein the determining includes determining whether to encrypt the received data, or to forward the received data as it is to the first storage device based on time at the receiving data received from the first computing device.

14. The computer-readable recording medium according to claim 11, wherein the encrypting includes encrypting the received data by using an encrypting key designated for each of the first computing device.

15. The computer-readable recording medium according to claim 11, wherein the computer program further causes the computer to execute:
receiving designating information from the first computing device; and
determining whether to encrypt the received data that is received from the first computing device or to forward the received data as it is to the first storage device based on received designating information.
